(19) United States
(12) Patent Application Publication
(10) Pub. No.: US 2021/0316914 A1
(43) Pub. Date: Oct. 14, 2021

(54) Child-Resistant Container and Related Methods

(71) Applicant: PWS Packaging Services, Inc., La Jolla, CA (US)

(72) Inventors: Justin Tidwell, BREA, CA (US); William Tidwell, BREA, CA (US)

(21) Appl. No.: 17/202,967

(22) Filed: Mar. 16, 2021

Related U.S. Application Data
(63) Continuation-in-part of application No. 16/847,863, filed on Apr. 14, 2020.

(51) Int. Cl. B65D 50/06; B65D 35/02; B65D 47/18; B65D 35/44; B05B 11/00

(52) U.S. Cl. CPC B65D 50/061; B65D 35/02; B05B 11/0008; B65D 35/44; B65D 47/18

(57) ABSTRACT

Disclosed is a child-resistant container with a notch and peg locking mechanism for storing cannabis flowers, edibles, concentrates, substances, pre-rolls, and vape cartridges.

### CROSS-REFERENCE TO RELATED APPLICATIONS

This application is a continuation-in-part of U.S. patent application Ser. No. 16/847,863 (filed Apr. 14, 2020), entitled Child-Resistant Container and Related Methods.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of child-resistant containers for storing substances, liquids, concentrates, solids, pre-rolls, and vape cartridges.

### Background of the Invention

With the increased sale and use of cannabis related products, there is an increased need for child-resistant containers and storage units for such products. As medicinal and recreational use of cannabis and cannabis related products increases, there are more requirements that these cannabis products be stored in child-resistant containers and packaging. For example, the state of California requires that all cannabis flower, pre-rolls, and cannabis products sold within California be in child-resistant packaging. Another product that is becoming increasingly popular is a vaporizer pen. Vaporizer pens are used in conjunction with vape cartridges, which contain cannabis oil. Since there are many different types of cannabis products, which come in different shapes and sizes, there are needs for child-resistant containers that can safely store a variety of different cannabis products.

Child resistant containers and packaging are also desirable for other types of products that may be toxic or harmful if consumed by a child. Accordingly, a need exits for a child-resistant container that can be used to store cannabis flower, edibles, concentrate, pre-rolls, vape cartridges, and other cannabis products.

### SUMMARY OF THE INVENTION

In view of the foregoing, an object of this specification is to disclose a container that is child-resistant.

It is another object of this specification to disclose a container with a peg and notch locking mechanism, wherein a cap must be manipulated in specific manner to open the container.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a perspective exploded view of one embodiment of the child-resistant container;

FIG. 2 is a front view of one embodiment of the child-resistant container in an open configuration;

FIG. 3 is a front view of one embodiment of the child-resistant container in a closed configuration;

FIG. 4 is a top view of one embodiment of the child-resistant container in a closed configuration;

FIG. 5 is a bottom view of one embodiment of the child-resistant container in a closed configuration;

FIG. 6 is a perspective view of one embodiment of the child-resistant container in a closed configuration;

FIG. 7 is a perspective view of one embodiment of the child-resistant container in a closed configuration;

FIG. 8 is a perspective exploded view of one embodiment of the child-resistant container;

FIG. 9 is a perspective exploded view of one embodiment of the child-resistant container in a closed configuration;

FIG. 10 is a front view of one embodiment of the child-resistant container in a closed configuration;

FIG. 11 is a front view of an alternative embodiment of the child-resistant container in a closed configuration;

FIG. 12 is a front view of an alternative embodiment of the child-resistant container in a closed configuration;

FIG. 13 is a front view of an alternative embodiment of the child-resistant container in a closed configuration;

FIG. 14 is a front view of an alternative embodiment of the child-resistant container in a closed configuration;

FIG. 15 is a front view of an alternative embodiment of the child-resistant container in an open configuration;

FIG. 16 is a front view of an alternative embodiment of the child-resistant container in a closed configuration;

FIG. 17 is a front view of an alternative embodiment of the child-resistant container in a closed configuration;

FIG. 18 is a front view of an alternative embodiment of the child-resistant container in a closed configuration;

FIG. 19 is a front view of an alternative embodiment of the child-resistant container in a closed configuration;

FIG. 20 is a front view of an alternative embodiment of the child-resistant container in a closed configuration;

FIG. 21 is a front view of an alternative embodiment of the child-resistant container in a closed configuration;

FIG. 22 is a front view of an alternative embodiment of the child-resistant container in an open configuration;

FIG. 23 is a front view of an alternative embodiment of the child-resistant container in an open configuration;

FIG. 24 is a top view of an alternative embodiment of the child-resistant container;

FIG. 25 is a bottom view of an alternative embodiment of the child-resistant container;

FIG. 26 is a perspective exploded view of an alternative embodiment of the child-resistant container;

FIG. 27 is a perspective exploded view of an alternative embodiment of the child-resistant container;

FIG. 28 is a front view of an alternative embodiment of the child-resistant container in an open configuration;

FIG. 29 is a front view of an alternative embodiment of the child-resistant container in a closed configuration;

FIG. 30 is a front view of an alternative embodiment of the child-resistant container in a closed configuration;

FIG. 31 is a front view of an alternative embodiment of the child-resistant container in a closed configuration;

FIG. 32 is a perspective exploded view of an alternative embodiment of the child-resistant container;

FIG. 33 is a perspective exploded view of an alternative embodiment of the child-resistant container;

FIG. 34 is a front view of an alternative embodiment of the child-resistant container in an open configuration;

FIG. 35 is a front view of an alternative embodiment of the child-resistant container in a closed configuration;

FIG. 36 is a front view of an alternative embodiment of the child-resistant container in a closed configuration;

FIG. 37 is a front view of an alternative embodiment of the child-resistant container in a closed configuration;

FIG. 38 is a perspective exploded view of an alternative embodiment of the child-resistant container;

FIG. 39 is a perspective exploded view of an alternative embodiment of the child-resistant container;

FIG. 40 is an exploded view of one embodiment of the child-resistant container with the components on the inside of the container shown in broken lines;

FIG. 41 is an exploded view of an alternative embodiment of the child-resistant container with the components on the inside of the container shown in broken lines;

FIG. 42 is an exploded view of an alternative embodiment of the child-resistant container with the components on the inside of the container shown in broken lines;

FIG. 43 is an exploded view of an alternative embodiment of the child-resistant container with the components on the inside of the container shown in broken lines;

FIG. 44 is an exploded view of an alternative embodiment of the child-resistant container with the components on the inside of the container shown in broken lines;

FIG. 45 is an exploded view of an alternative embodiment of the child-resistant container with the components on the inside of the container shown in broken lines;

FIG. 46 is an exploded view of an alternative embodiment of the child-resistant container with the components on the inside of the container shown in broken lines;

FIG. 47 is an exploded view of an alternative embodiment of the child-resistant container with the components on the inside of the container shown in broken lines;

FIG. 48 is a perspective exploded view of one embodiment of the child-resistant container;

FIG. 49 is a perspective exploded view of one embodiment of the child-resistant container;

FIG. 50 is a perspective exploded view of one embodiment of the child-resistant container;

FIG. 51 is a perspective exploded view of one embodiment of the child-resistant container;

FIG. 52 is a perspective exploded view of one embodiment of the child-resistant container;

FIG. 53 is a perspective exploded view of one embodiment of the child-resistant container;

FIG. 54 is a perspective exploded view of one embodiment of the child-resistant container;

FIG. 55 is a perspective exploded view of one embodiment of the child-resistant container;

FIG. 56 is a perspective exploded view of one embodiment of the child-resistant container; and,

FIG. 57 is a perspective exploded view of one embodiment of the child-resistant container.

FIG. 58 is a front view of one embodiment of the child-resistant container in a closed configuration.

FIG. 59 is a front view of one embodiment of the child-resistant container in a closed configuration.

FIG. 60 is a front view of one embodiment of the child-resistant container in a closed configuration.

FIG. 61 is a front view of one embodiment of the child-resistant container in a closed configuration.

FIG. 62 is a perspective exploded view of one embodiment of the child-resistant container.

FIG. 63 is a perspective exploded view of one embodiment of the child-resistant container of FIG. 62.

FIG. 64 is a front view of one embodiment of the child-resistant container of FIG. 62.

FIG. 65 is a side view of one embodiment of the child-resistant container of FIG. 62.

FIG. 66 is a perspective view of one embodiment of the child-resistant container of FIG. 62.

FIG. 67 is a perspective view of one embodiment of the child-resistant container of FIG. 62.

FIG. 68 is a perspective exploded view of one embodiment of the child-resistant container.

FIG. 69 is a perspective exploded view of one embodiment of the child-resistant container of FIG. 68.

FIG. 70 is a front view of one embodiment of the child-resistant container of FIG. 68.

FIG. 71 is a side view of one embodiment of the child-resistant container of FIG. 68.

FIG. 72 is a perspective view of one embodiment of the child-resistant container of FIG. 68.

FIG. 73 is a perspective view of one embodiment of the child-resistant container of FIG. 68.

FIG. 74 is a front view of one embodiment of the child-resistant container in a closed configuration.

FIG. 75 is a front view of one embodiment of the child-resistant container in a closed configuration.

FIG. 76 is a front view of one embodiment of the child-resistant container in a closed configuration.

FIG. 77 is a front view of one embodiment of the child-resistant container in a closed configuration.

FIG. 78 is a front view of one embodiment of the child-resistant container of FIG. 74.

FIG. 79 is a front view of one embodiment of the child-resistant container of FIG. 75.

FIG. 80 is a front view of one embodiment of the child-resistant container of FIG. 77.

FIG. 81 is a front view of one embodiment of the child-resistant container of FIG. 76.

FIG. 82 is a perspective exploded view of one embodiment of the child-resistant container of FIG. 75.

FIG. 83 is a perspective exploded view of one embodiment of the child-resistant container of FIG. 75.

FIG. 84 is a perspective view of one embodiment of the child-resistant container of FIG. 75.

FIG. 85 is a perspective view of one embodiment of the child-resistant container of FIG. 75.

FIG. 86 is a front view of one embodiment of the child-resistant container in a closed configuration.

FIG. 87 is a front view of one embodiment of the child-resistant container in a closed configuration.

FIG. 88 is a front view of one embodiment of the child-resistant container in a closed configuration.

FIG. 89 is a front exploded view of one embodiment of the child-resistant container.

FIG. 90 is a back exploded view of one embodiment of the child-resistant container of FIG. 89.

FIG. 91 is a side exploded view of one embodiment of the child-resistant container of FIG. 89.

FIG. 92 is a perspective exploded view of one embodiment of the child-resistant container of FIG. 89.

FIG. 93 is a perspective exploded view of one embodiment of the child-resistant container of FIG. 89.

FIG. 94 is a perspective exploded view of one embodiment of the child-resistant container of FIG. 89.

FIG. 95 is a perspective exploded view of one embodiment of the child-resistant container of FIG. 89.

FIG. 96 is a front exploded view of one embodiment of the child-resistant container.

FIG. 97 is a back exploded view of one embodiment of the child-resistant container of FIG. 96.

FIG. 98 is a side exploded view of one embodiment of the child-resistant container of FIG. 96.

FIG. 99 is a perspective exploded view of one embodiment of the child-resistant container of FIG. 96.

FIG. 100 is a perspective exploded view of one embodiment of the child-resistant container of FIG. 96.

FIG. 101 is a perspective exploded view of one embodiment of the child-resistant container of FIG. 96.

FIG. 102 is a perspective exploded view of one embodiment of the child-resistant container of FIG. 96.

FIG. 103 is a front exploded view of one embodiment of the child-resistant container.

FIG. 104 is a back exploded view of one embodiment of the child-resistant container of FIG. 103.

FIG. 105 is a side exploded view of one embodiment of the child-resistant container of FIG. 103.

FIG. 106 is a perspective exploded view of one embodiment of the child-resistant container of FIG. 103.

FIG. 107 is a perspective exploded view of one embodiment of the child-resistant container of FIG. 103.

FIG. 108 is a perspective exploded view of one embodiment of the child-resistant container of FIG. 103.

FIG. 109 is a perspective exploded view of one embodiment of the child-resistant container of FIG. 103.

FIG. 110 is a front exploded view of one embodiment of the child-resistant container.

FIG. 111 is a front exploded view of one embodiment of the child-resistant container.

FIG. 112 is a front exploded view of one embodiment of the child-resistant container.

FIG. 113 is a perspective exploded view of one embodiment of the child-resistant container.

FIG. 114 is a perspective exploded view of one embodiment of the child-resistant container.

FIG. 115 is a perspective exploded view of one embodiment of the child-resistant container.

FIG. 116 is a perspective exploded view of one embodiment of the child-resistant container.

FIG. 117 is a perspective exploded view of one embodiment of the child-resistant container.

FIG. 118 is a perspective exploded view of one embodiment of the child-resistant container.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

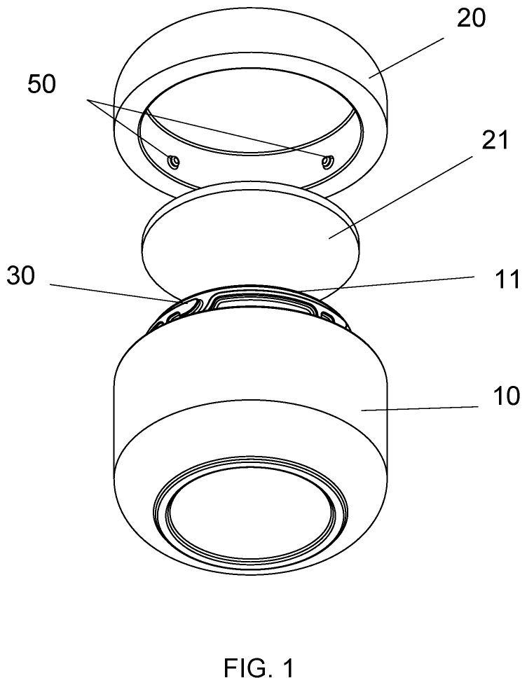

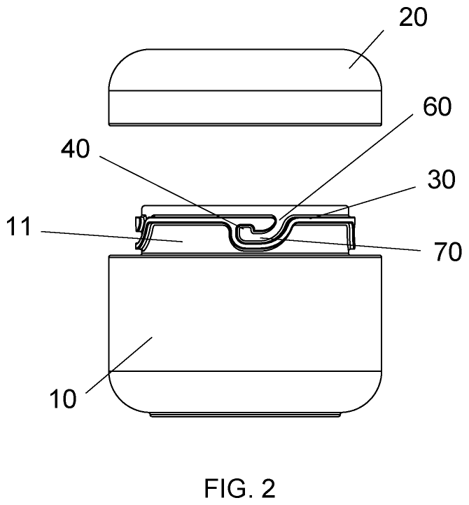

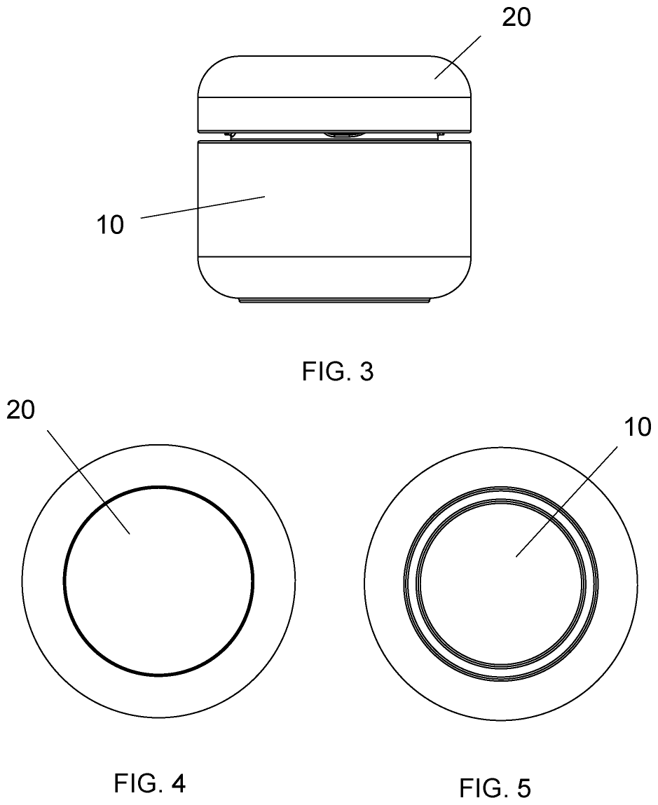

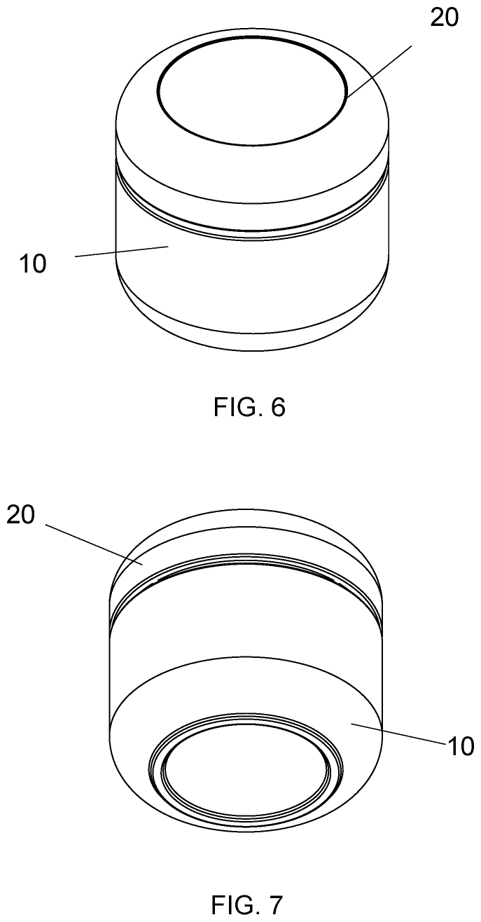

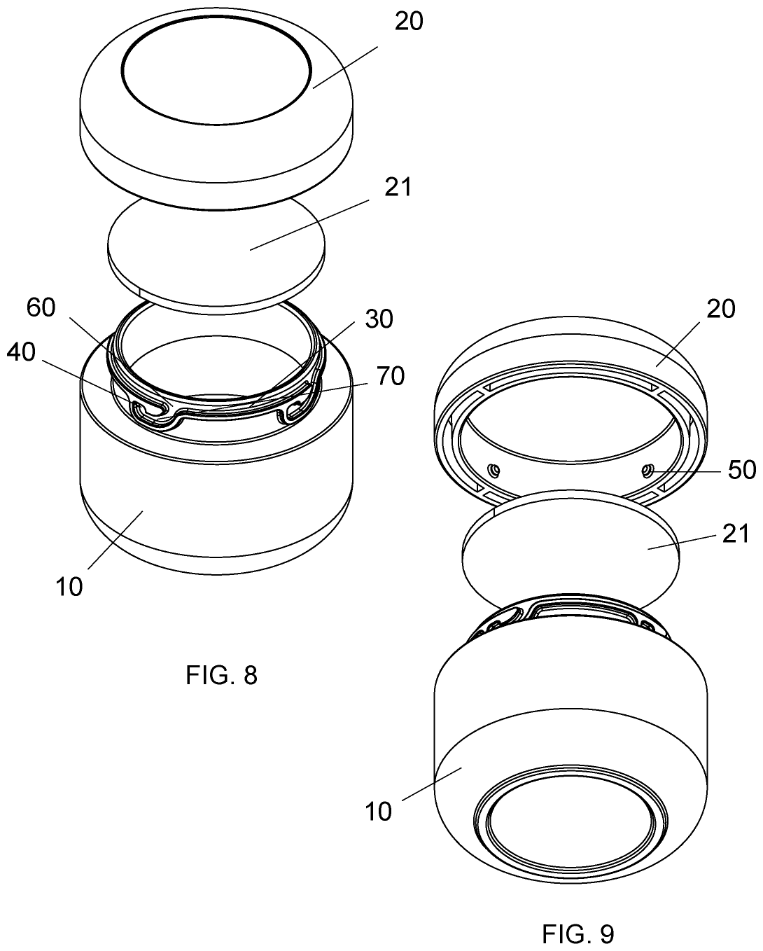

Disclosed are several embodiments of a child-resistant container. FIG. 1 is a perspective view of one embodiment of the child resistant container in an open configuration; FIG. 2 is a front view of one embodiment of the child-resistant container in an open configuration; FIG. 3 is a front view of one embodiment of the child-resistant container in a closed configuration; FIG. 4 is a top view of one embodiment of the child-resistant container in a closed configuration; FIG. 5 is a bottom view of one embodiment of the child-resistant container in a closed configuration; FIG. 6 is a perspective view of one embodiment of the child-resistant container in a closed configuration; FIG. 7 is a perspective view of one embodiment of the child-resistant container in a closed configuration; FIG. 8 is a perspective exploded view of one embodiment of the child-resistant container; and, FIG. 9 is a perspective exploded view of one embodiment of the child-resistant container in a closed configuration.

These figures show the child-resistant container, which features a body 10 and a cap 20. Referring to FIGS. 1 and 2, the body 10 features an opening with a neck 11 that has threads 30. The threads 30 feature an inlet 60, a track 70, and a notch 40. In a preferred embodiment, the threads 30 features at least one inlet 60 that starts at the tip of the neck and travels down a track 70 in a curved path that is down and away from the inlet 60, wherein the track 70 meets a terminal end wall that leads up to a notch 40, which travels slightly back up the neck 11 and is surrounded by a wall on the top and sides. In a preferred embodiment, the neck features four threads 30, which results in four inlets 60, tracks 70, and notches 40. In a preferred embodiment, the threads 30 are equidistant or equiradial from each other.

Still referring to FIGS. 1 and 2, the cap 20 features pegs 50 that are located on the inside wall of the cap 20 and a cap membrane 21 that rests against the base inside the cap 20. In a preferred embodiment, the pegs 50 are designed to slide within the inlet 60 and track 70 of the threads 30 and lock into place into the notches 40. Accordingly, the pegs 50 allow a user to secure the cap on the body 10 by engaging at least one peg 50 with at least one notch 40. In a preferred embodiment, the pegs 50 are suitably located approximately halfway up the height of the inside wall of the cap 20.

In a preferred embodiment, the cap membrane is comprised of a compressible material that can be compressed and decompressed to regain its form like foam or rubber. The compressibility of cap membrane 21, allows the pegs 50 to securely lock into place within the notches 40. That is, in use, when a user pushes down against the cap, the edges of the neck 11 press against the cap membrane 21 to compress it and when the user releases the cap, the cap membrane 21 will decompress and force the cap 20 and pegs 50 in an upward motion. If turning the cap to a locked position, this decompression of the cap membrane 21 will force the pegs 50 into the notches 40 and secure the pegs 50 into the notches 40. If removing the cap 20, the compression of the cap membrane 21 allows the pegs 50 to travel down and out of the notches 40. As discussed throughout this application, the peg and notch locking mechanism through the use of a cap membrane 21 is a feature of child resistance for opening the case.

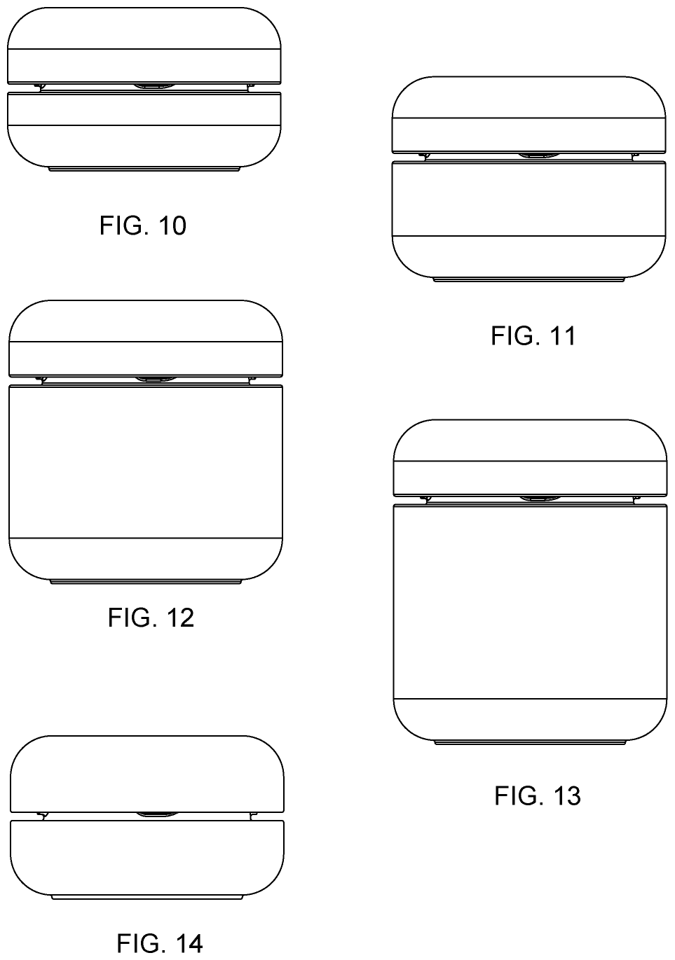

FIG. 10 is a front view of one embodiment of the child-resistant container in a closed configuration; FIG. 11 is a front view of an alternative embodiment of the child-resistant container in a closed configuration; FIG. 12 is a front view of an alternative embodiment of the child-resistant container in a closed configuration; FIG. 13 is a front view of an alternative embodiment of the child-resistant container in a closed configuration; and, FIG. 14 is a front view of an alternative embodiment of the child-resistant container in a closed configuration.

Referring to FIGS. 10-14, Referring to FIGS. 10-14, the cap may be more rounded around the edges to resemble an ellipsoid.

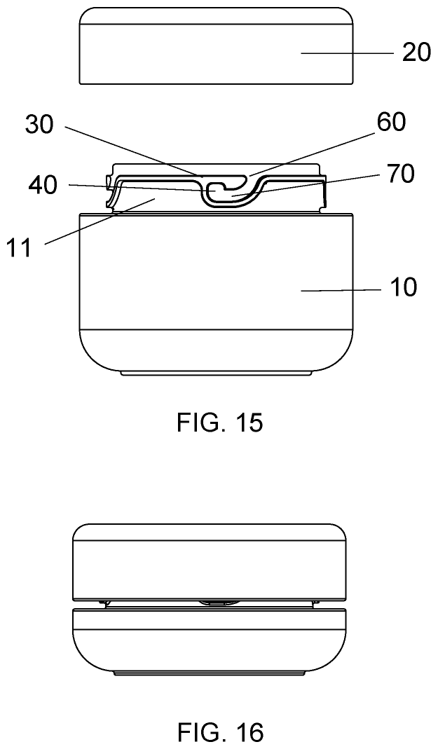

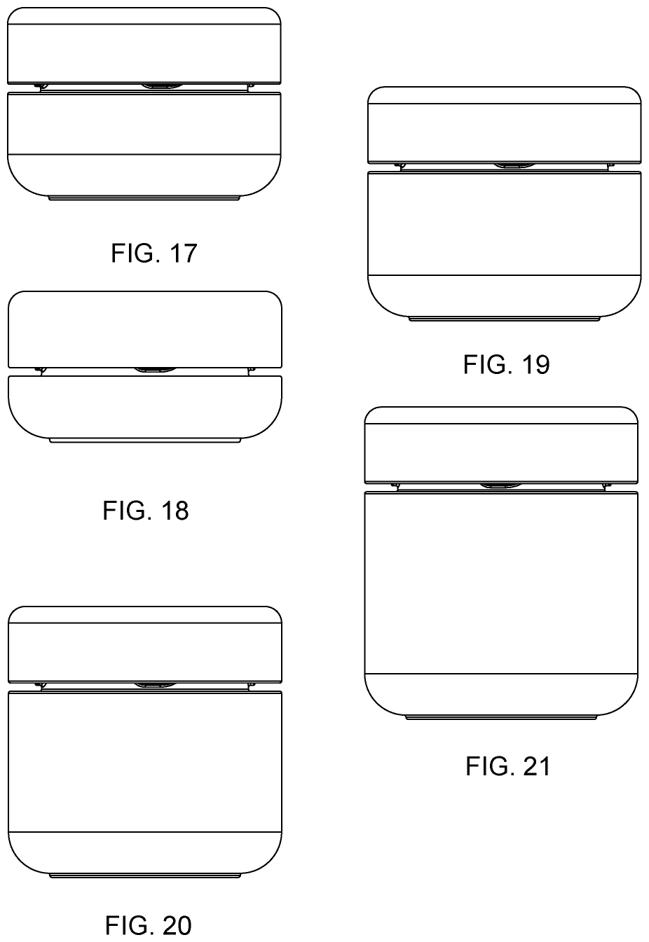

FIG. 15 is a front view of an alternative embodiment of the child-resistant container in an open configuration; FIG. 16 is a front view of an alternative embodiment of the child-resistant container in a closed configuration; FIG. 17 is a front view of an alternative embodiment of the child-resistant container in a closed configuration; FIG. 18 is a front view of an alternative embodiment of the child-resistant container in a closed configuration; FIG. 19 is a front view of an alternative embodiment of the child-resistant container in a closed configuration; FIG. 20 is a front view of an alternative embodiment of the child-resistant container in a closed configuration; and, FIG. 21 is a front view of an alternative embodiment of the child-resistant container in a closed configuration. Referring to FIGS. 15-21, the cap may be less rounded on the edges and resemble more of a cylinder.

Referring to FIGS. 10-14 and 16-21, the containers may come in different embodiments and different sizes to hold volumes of 5 mL, 7, mL, or 9 mL of liquid, concentrate, or other substance. The containers may also come in different sizes to hold volumes of 1, 2, 3, 4, or 5 ounces of liquid substance or concentrate. In a preferred embodiment, the child-resistant container is suitably used to store cannabis flower, edibles, and/or concentrates.

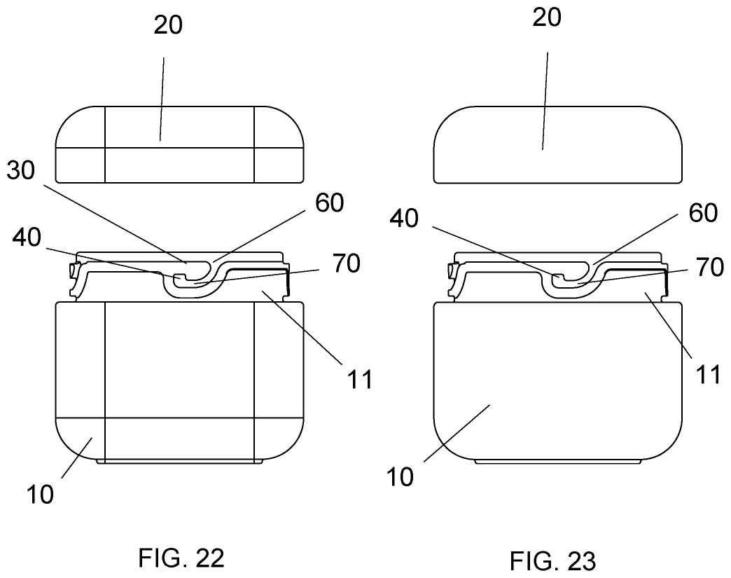

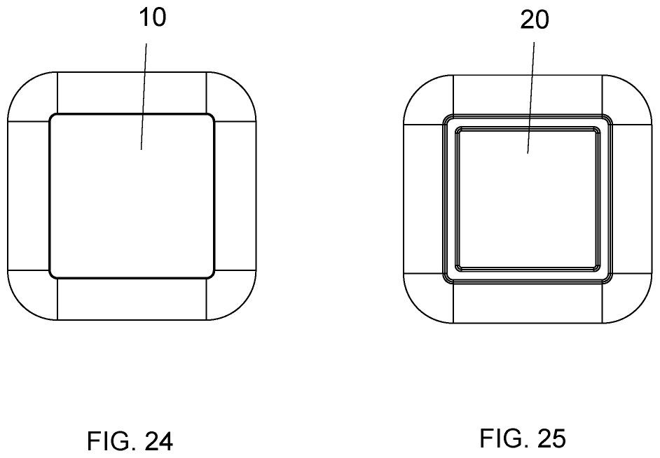

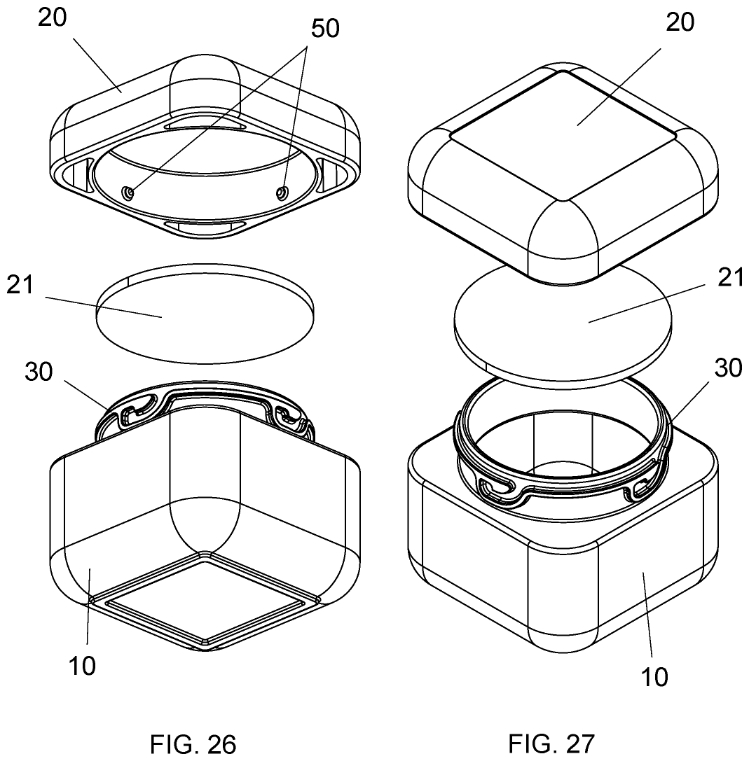

FIG. 22 is a front view of an alternative embodiment of the child-resistant container in an open configuration; FIG. 23 is a front view of an alternative embodiment of the child-resistant container in an open configuration; FIG. 24 is a top view of an alternative embodiment of the child-resistant container; FIG. 25 is a bottom view of an alternative embodiment of the child-resistant container; FIG. 26 is a perspective exploded view of an alternative embodiment of the child-resistant container; and, FIG. 27 is a perspective exploded view of an alternative embodiment of the child-resistant container.

Referring to FIGS. 22-27, in one embodiment, the the child-resistant container may be shaped like a cube. In different embodiments, the child-resistant container may be in the shape of a cylinder, cuboid, ellipsoid, and/or an elongated tube. In one embodiment the body 10 of the child-resistant container may be comprised of glass. In an alternative embodiment, the body 10 of the child-resistant container may be comprised of a rigid plastic. In another alternative embodiment, the body 10 of the child-resistant container may be comprised of a metal. In a preferred embodiment, the cap 20 of the child resistant container may be comprised of a rigid plastic or metal.

In use, a user may store liquid, concentrate, or a solid in the child resistant container by: (i) obtaining a container with a body 10 and a cap 20, wherein the body 10 has a neck 11 with threads 30 that feature an inlet 60, track 70, and notch 40, and wherein the cap 20 features pegs 50 and a cap membrane 21 in communication with the inside base of the cap 20; (ii) pushing the cap 20 down, wherein the pegs 50 travel down and out of the notch 40 and into the track 70; (iii) twisting the cap 20 in a counter-clockwise manner, wherein the pegs 50 travel along the track 70 and out of the inlet, (iv) removing the cap 20 by pulling it off of the body 10; (v) placing a liquid, substance, or concentrate into the body 10 of the container; (vi) placing the cap 20 onto the neck 11 of the body 10, (vii) aligning the pegs 50 with the inlet 60 of the threads 30; (viii) twisting the cap 20 in a clockwise manner, wherein the pegs 50 travel along the track 70 until they hit the terminal end wall of the track; and, (ix) pulling or releasing the cap 20 to allow the pegs 50 to lock into a secured position in the notches 40.

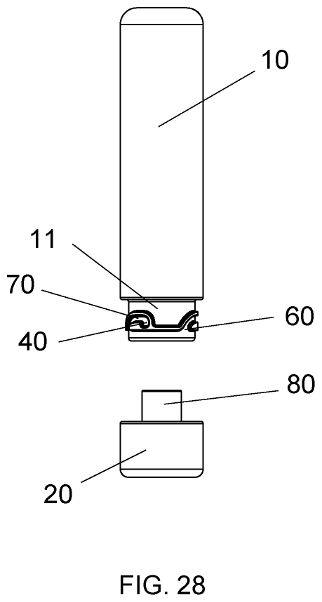

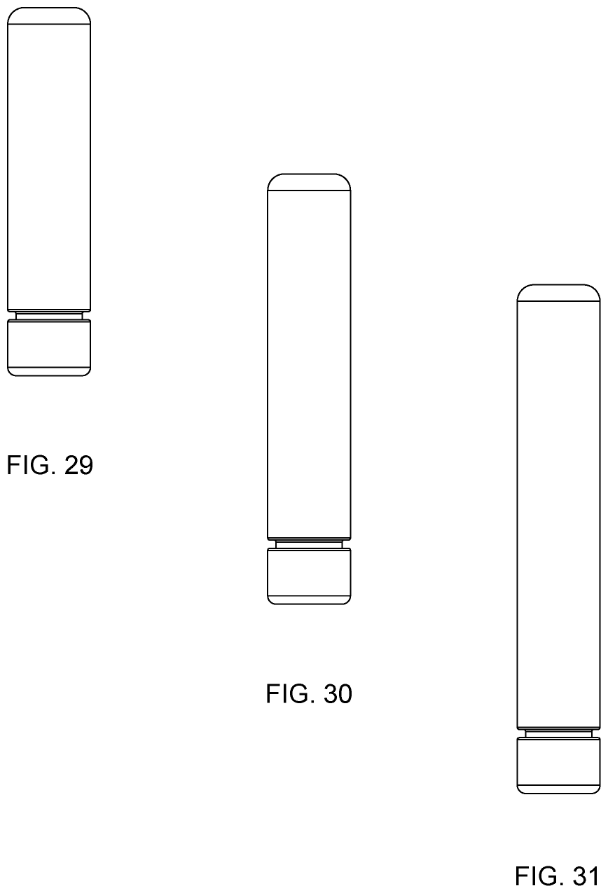

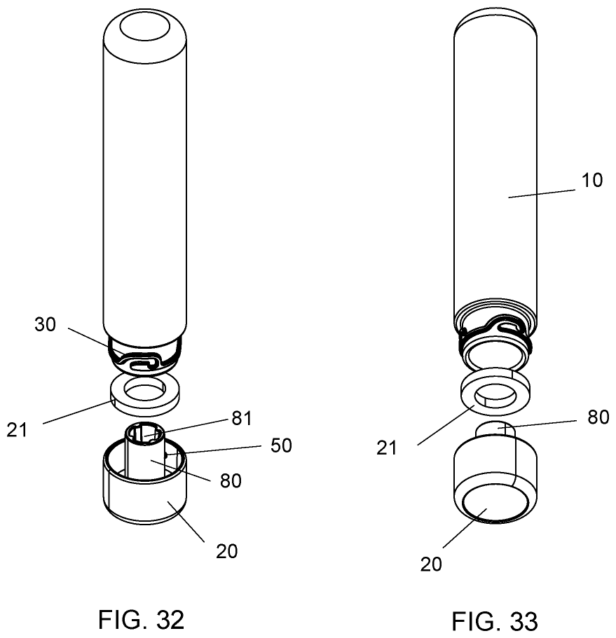

FIG. 28 is a front view of an alternative embodiment of the child-resistant container in an open configuration; FIG. 29 is a front view of an alternative embodiment of the child-resistant container in a closed configuration; FIG. 30 is a front view of an alternative embodiment of the child-resistant container in a closed configuration; FIG. 31 is a front view of an alternative embodiment of the child-resistant container in a closed configuration; FIG. 32 is a perspective exploded view of an alternative embodiment of the child-resistant container; and, FIG. 33 is a perspective exploded view of an alternative embodiment of the child-resistant container.

Referring to FIGS. 28-34, in an alternative embodiment, the child-resistant container is a rounded tube. Referring to FIGS. 32 and 33, the cap 20 features pegs 50 and the cap 20 may feature a cap membrane 21 that is in the shape of a ring to support the inside base of the cap 20.

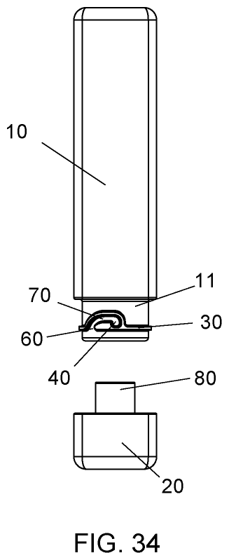

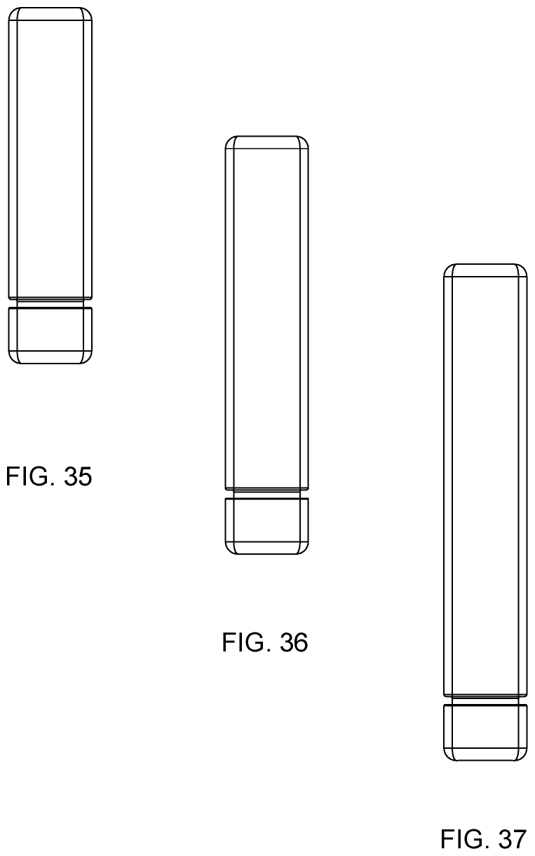

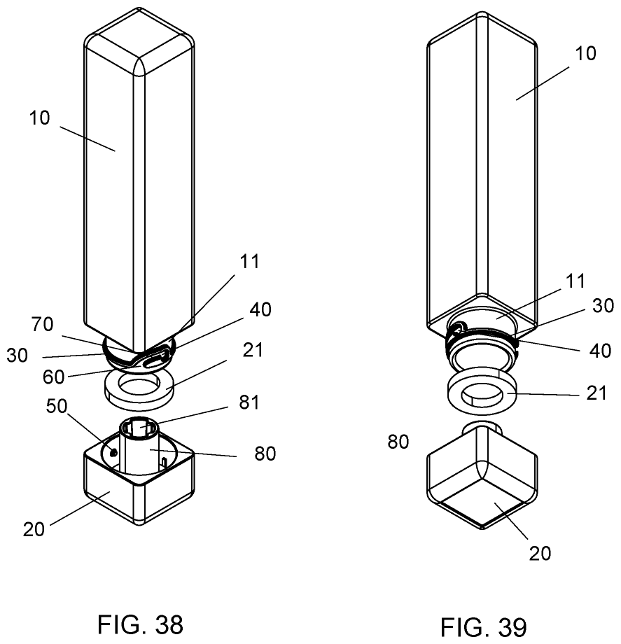

FIG. 34 is a front view of an alternative embodiment of the child-resistant container in an open configuration; FIG. 35 is a front view of an alternative embodiment of the child-resistant container in a closed configuration; FIG. 36 is a front view of an alternative embodiment of the child-resistant container in a closed configuration; FIG. 37 is a front view of an alternative embodiment of the child-resistant container in a closed configuration; FIG. 38 is a perspective exploded view of an alternative embodiment of the child-resistant container; and, FIG. 39 is a perspective exploded view of an alternative embodiment of the child-resistant container.

Referring to FIGS. 34 to 39, in an alternative embodiment, the child-resistant container is a rectangular tube with squared off edges. Referring to FIGS. 29-31 and 35-37, the tube child-resistant containers may be 85 mm, 95 mm, and/or 110 mm in length. Referring to FIGS. 38 and 39, the cap 20 features pegs 50 and the cap 20 may feature a cap membrane 21 that is in communication with the base of the cap 20 and in the shape of a ring to surround the housing 80.

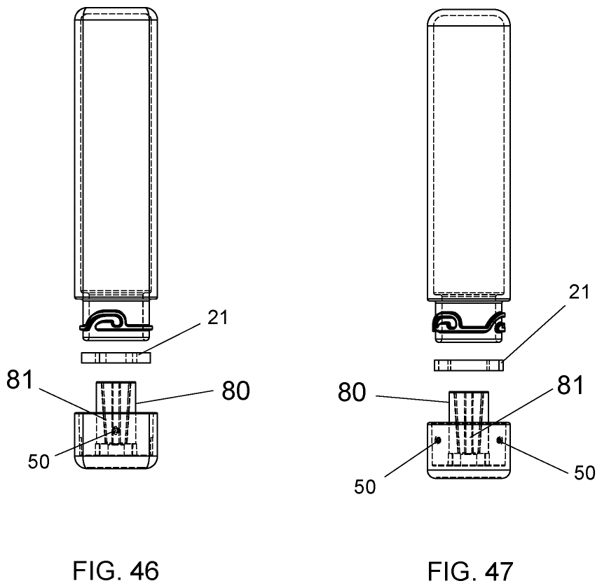

Referring to FIGS. 28, 32, 33, 34, 38, and 39, the containers may be in the shape of a tube and feature a housing 80 in the cap 20, wherein the housing 80 is defined by a slot 81 (See FIG. 46-47), wherein a pre-rolled joint or cigarette (“pre-roll”) or a vape cartridge may be inserted for easy storage in the container. Accordingly, in a preferred embodiment, the container that is in a shape of a tube holds and stores a pre-rolled joint, or a vape cartridge.

Referring to FIGS. 28-39, in use, a user may store a pre-roll or a vape cartridge in the child resistant container by: (i) obtaining a container with a body 10 and a cap 20, wherein the body 10 is in the shape of a tube and has a neck 11 with threads 30 that feature an inlet 60, track 70, and notch 40, and wherein the cap 20 features pegs 50, a cap membrane 21 in communication with the inside base of the cap 20, and a housing 80; (ii) pushing the cap 20 down, wherein the pegs 50 travel down and out of the notch 40 and into the track 70; (iii) twisting the cap 20 in a counter-clockwise manner, wherein the pegs 50 travel along the track 70 and out of the inlet, (iv) removing the cap 20 by pulling it off of the body 10; (v) inserting a pre-roll or a vape cartridge into the housing 80 in the cap 20 of the child resistant container; (vi) placing the cap 20 onto the neck 11 of the body 10, whereby the pre-roll or vape cartridge is stored inside the body; (vii) aligning the pegs 50 with the inlet 60 of the threads 30; (viii) twisting the cap 20 in a clockwise manner, wherein the pegs 50 travel along the track 70 until they hit the terminal end wall of the track; and, (ix) releasing the cap 20, whereby the decompression of the cap membrane 21 allows the pegs 50 to lock into a secured position in the notches 40.

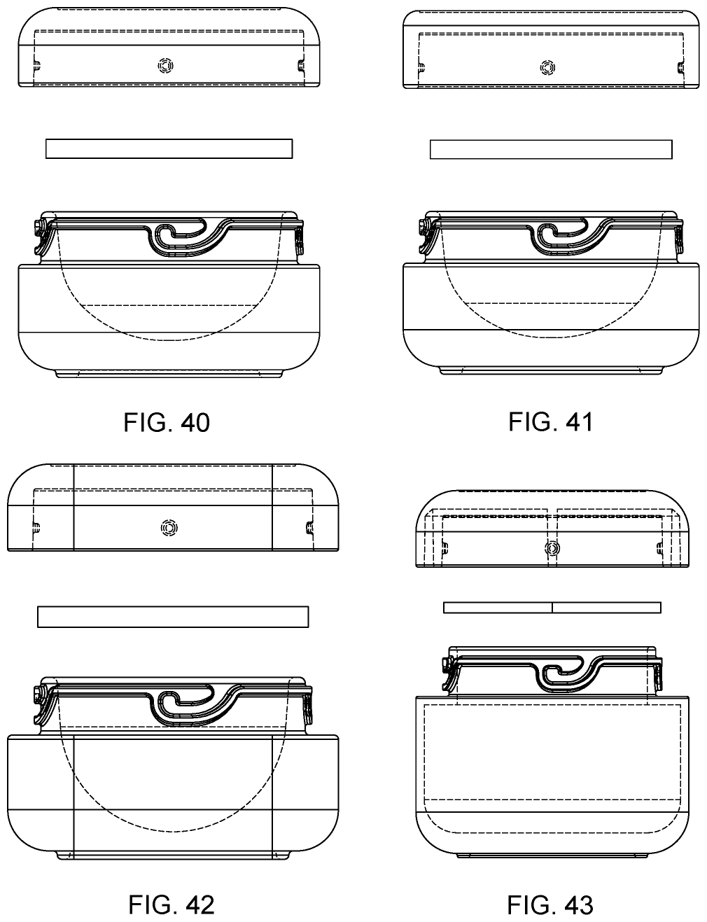

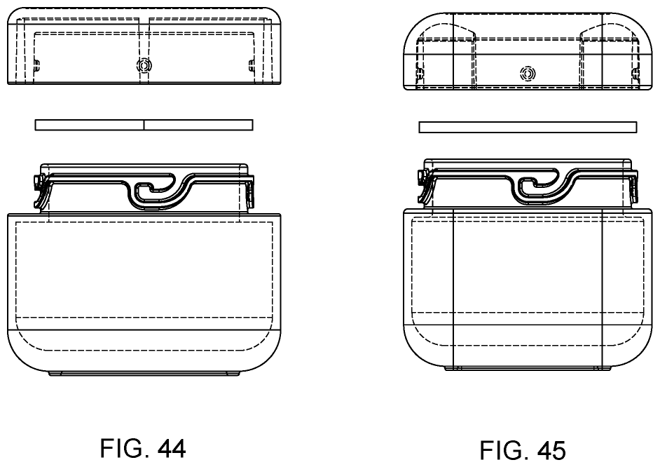

FIGS. 40-47 are exploded views of different embodiments of the child-resistant container with the components and spaces on the inside of the container shown in broken lines.

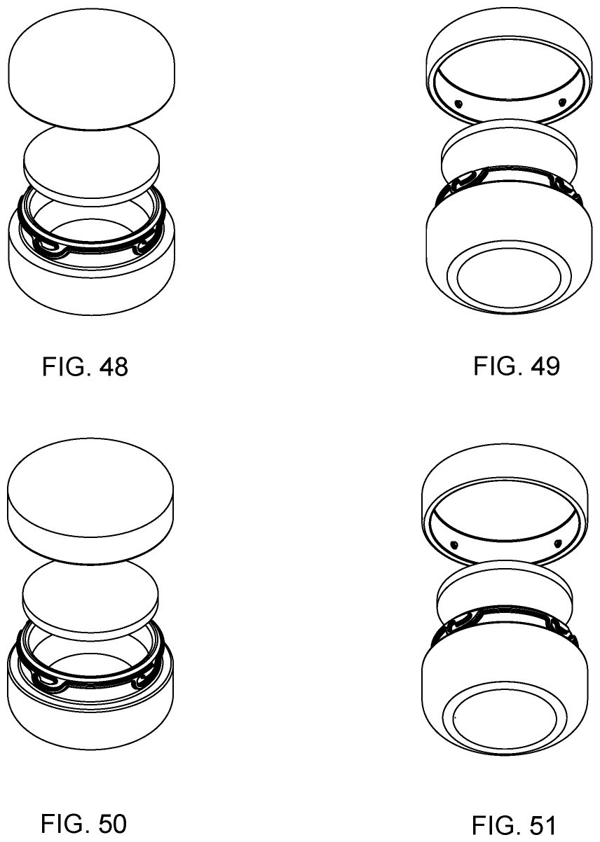

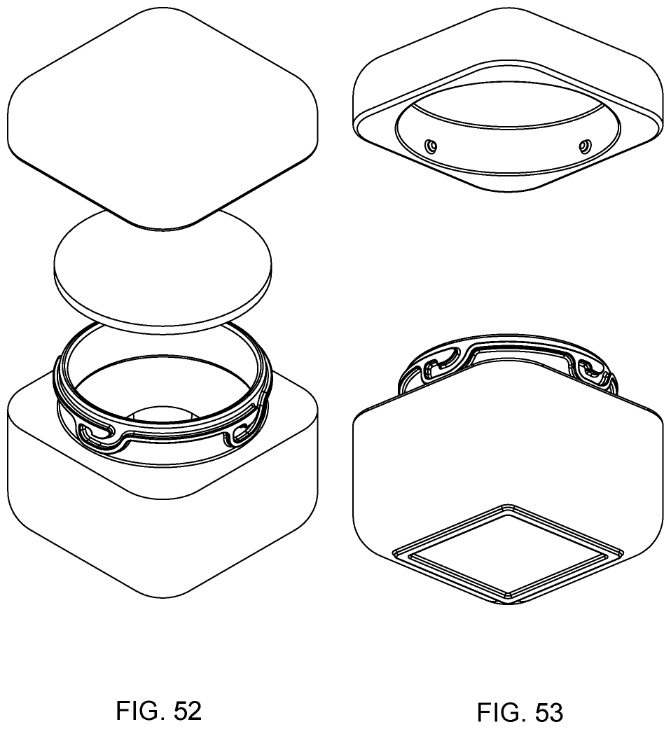

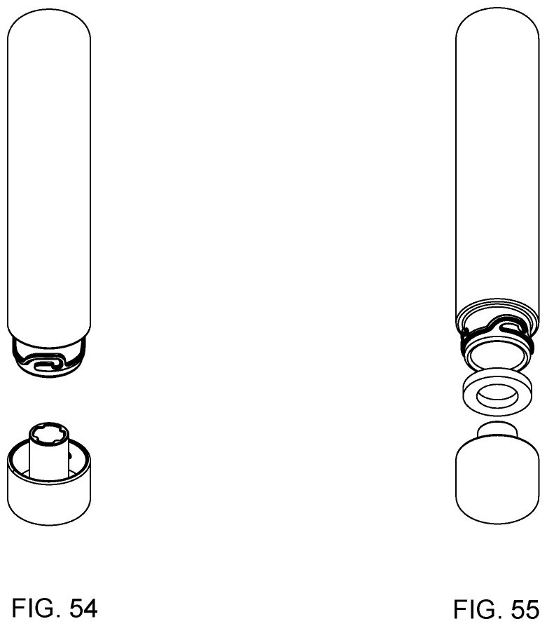

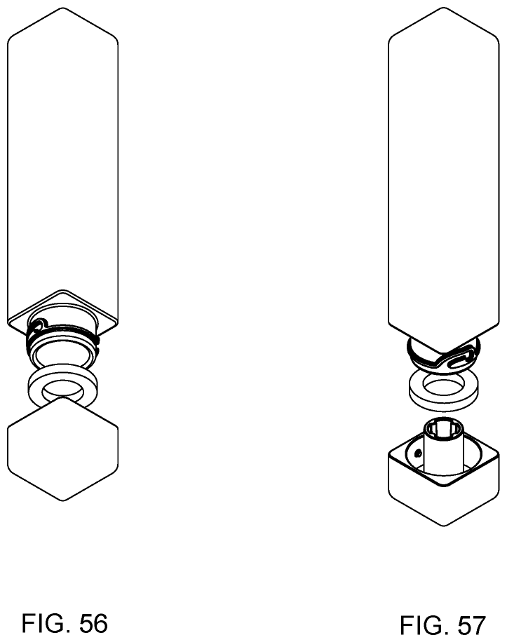

FIGS. 48-57 are perspective exploded views of different embodiments of the child-resistant container.

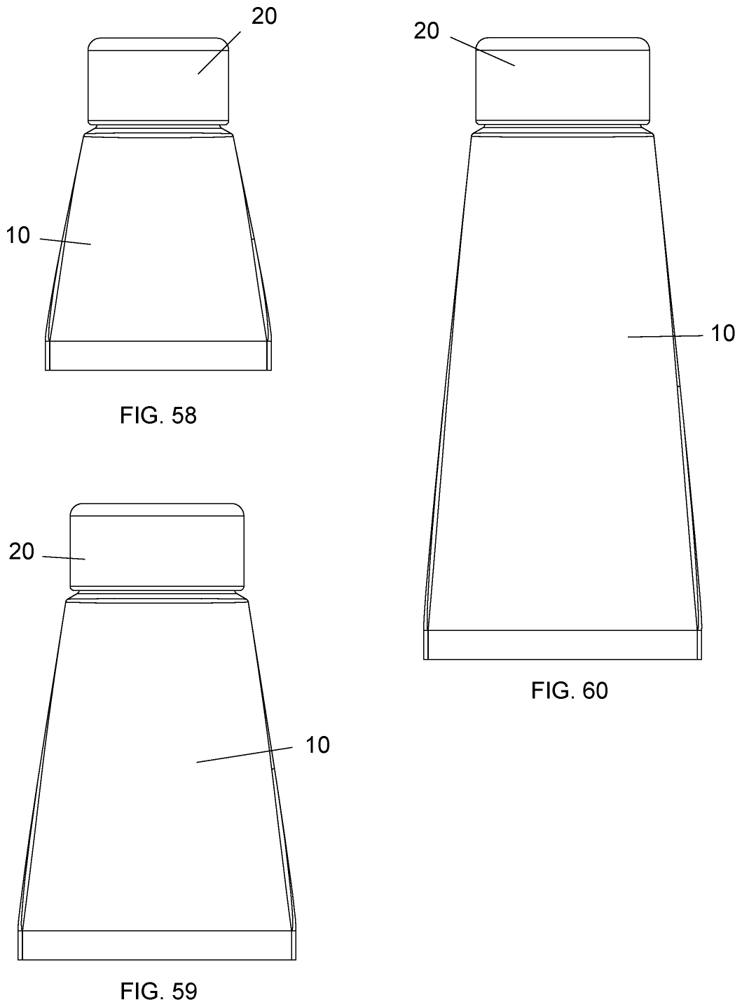

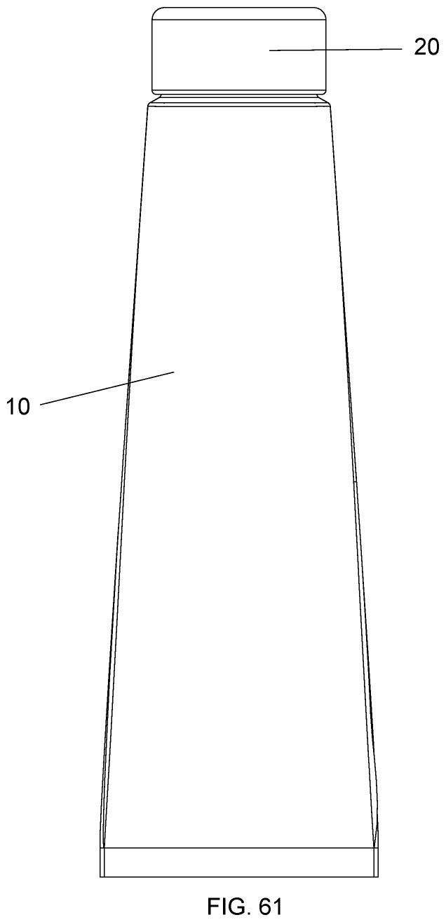

FIG. 58 is a front view of one embodiment of the child-resistant container in a closed configuration; FIG. 59 is a front view of one embodiment of the child-resistant container in a closed configuration; FIG. 60 is a front view of one embodiment of the child-resistant container in a closed configuration; and, FIG. 61 is a front view of one embodiment of the child-resistant container in a closed configuration. Referring to FIGS. 58-61, the child-resistant container may be a squeeze tube for pastes, gels, lotions, and substances of similar consistencies. The child-resistant containers may be squeeze tube and the squeeze tubes may come in different sizes, such as 1 oz or 5 oz tubes. The child-resistant container squeeze tubes may also be a variety of heights. In a preferred embodiment, the child-resistant containers may be 1 inch high, 2 inches high, or 3 inches high.

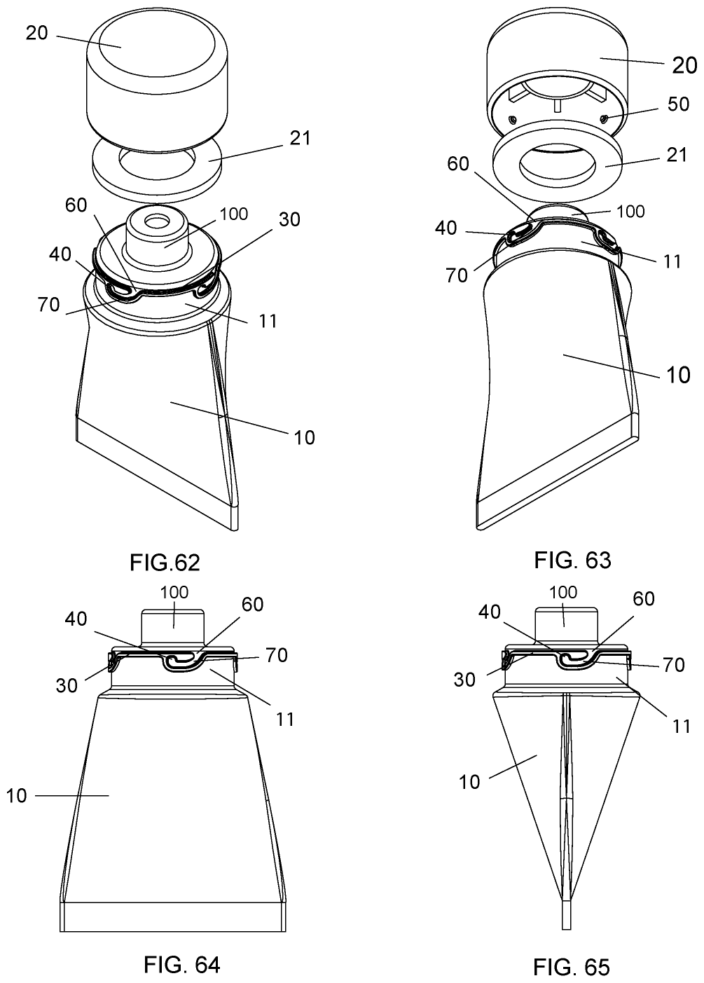

FIG. 62 is a perspective exploded view of one embodiment of the child-resistant container; FIG. 63 is a perspective exploded view of one embodiment of the child-resistant container of FIG. 62; FIG. 64 is a front view of one embodiment of the child-resistant container of FIG. 62; and, FIG. 65 is a side view of one embodiment of the child-resistant container of FIG. 62. Referring to FIGS. 62-65, in addition to the body 10, cap 20, cap membrane 21, pegs 50, neck 11, threads 30, inlet 60, track 70, and notch 40, the child-resistant container in a squeeze tube configuration may feature a nozzle 100 that is located on top of the neck 11. In use, a user may squeeze the tube, which forces pastes, gels, liquids, and/or lotions to protrude from the nozzle.

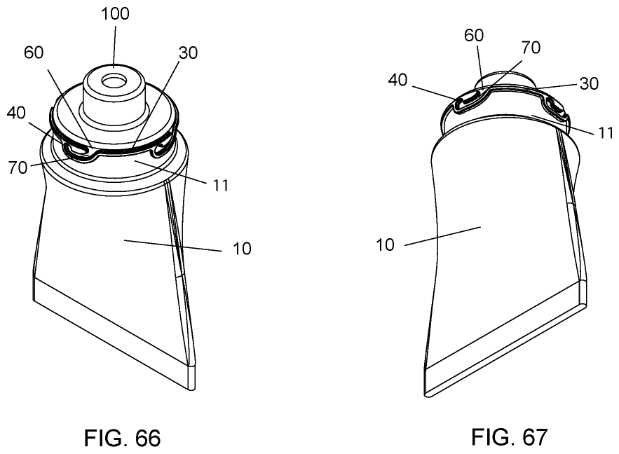

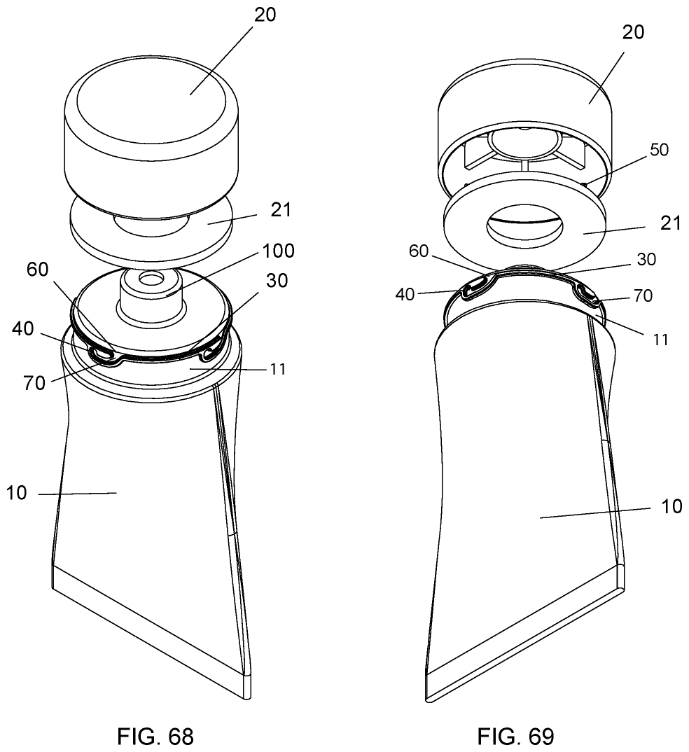

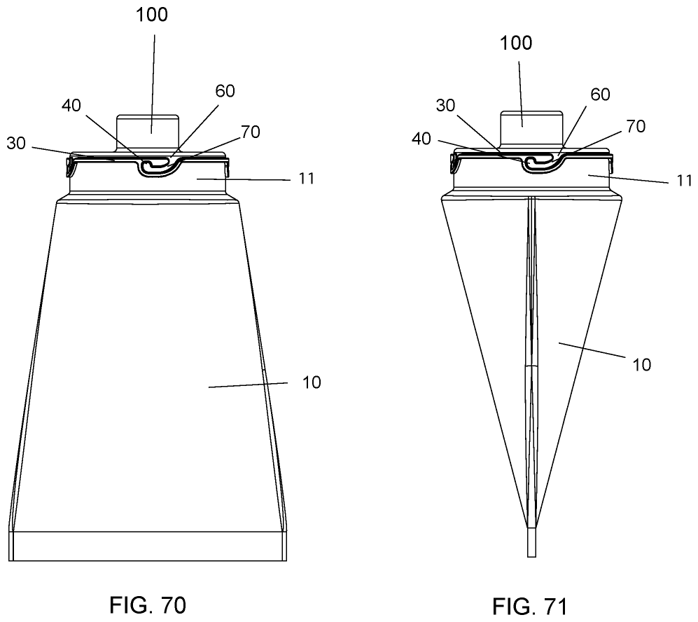

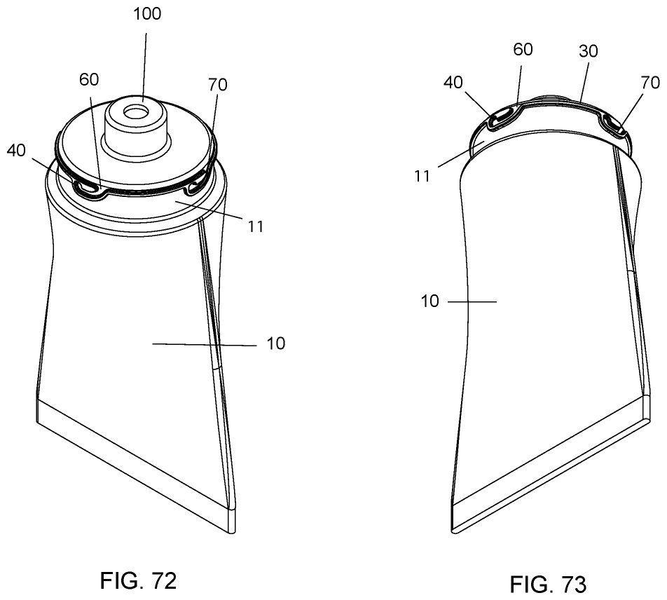

FIG. 66 is a perspective view of one embodiment of the child-resistant container of FIG. 62; FIG. 67 is a perspective view of one embodiment of the child-resistant container of FIG. 62; FIG. 68 is a perspective exploded view of one embodiment of the child-resistant container; FIG. 69 is a perspective exploded view of one embodiment of the child-resistant container of FIG. 68; FIG. 70 is a front view of one embodiment of the child-resistant container of FIG. 68; FIG. 71 is a side view of one embodiment of the child-resistant container of FIG. 68; FIG. 72 is a perspective view of one embodiment of the child-resistant container of FIG. 68; and, FIG. 73 is a perspective view of one embodiment of the child-resistant container of FIG. 68. FIGS. 66-73 are representative embodiments of the different sizes of different sizes of the child-resistant container in a squeeze tube configuration.

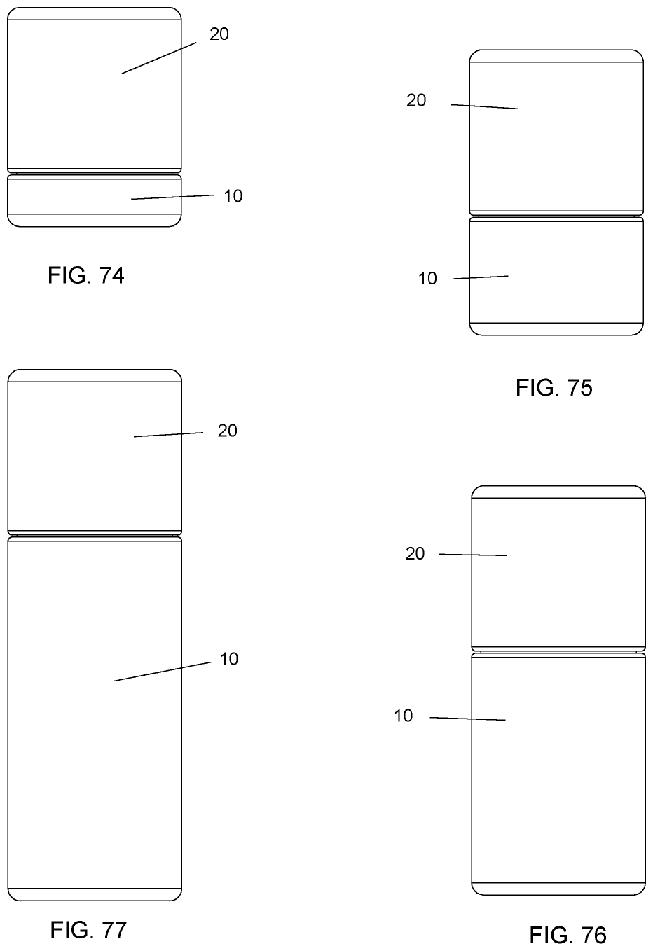

FIG. 74 is a front view of one embodiment of the child-resistant container in a closed configuration; FIG. 75 is a front view of one embodiment of the child-resistant container in a closed configuration; FIG. 76 is a front view of one embodiment of the child-resistant container in a closed configuration; and, FIG. 77 is a front view of one embodiment of the child-resistant container in a closed configuration. Referring to FIGS. 74-77, the child-resistant container may be in the form of a roll-on tube. In different embodiments, the child-resistant roll-on container may be configured to hold 0.5 ounces, 1 ounce, 2 ounces, or 3 ounces of a substance. The container may also be configured to hold other amounts of substances. Still referring to FIGS. 74-77, the cap 20 may be approximately 40 mm high and 42 mm in diameter. In several embodiments, the body 10 may range from 12.5 mm high to 88 mm high and be approximately 42 mm in diameter.

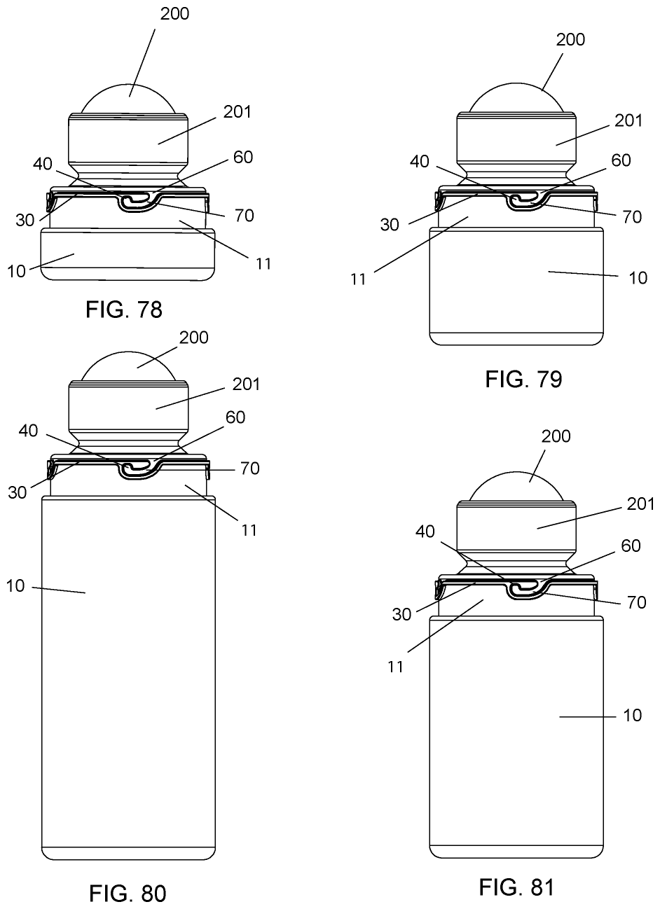

FIG. 78 is a front view of one embodiment of the child-resistant container of FIG. 74; FIG. 79 is a front view of one embodiment of the child-resistant container of FIG. 75; FIG. 80 is a front view of one embodiment of the child-resistant container of FIG. 77; and, FIG. 81 is a front view of one embodiment of the child-resistant container of FIG. 76. Referring to FIGS. 78 to 81, the child-resistant roll-on container is defined by a ball 200 that is placed within a housing 201, wherein the housing 201 is configured to hold the ball 200 in place but allows the ball 200 to roll within the housing 201 without falling out of the housing 201.

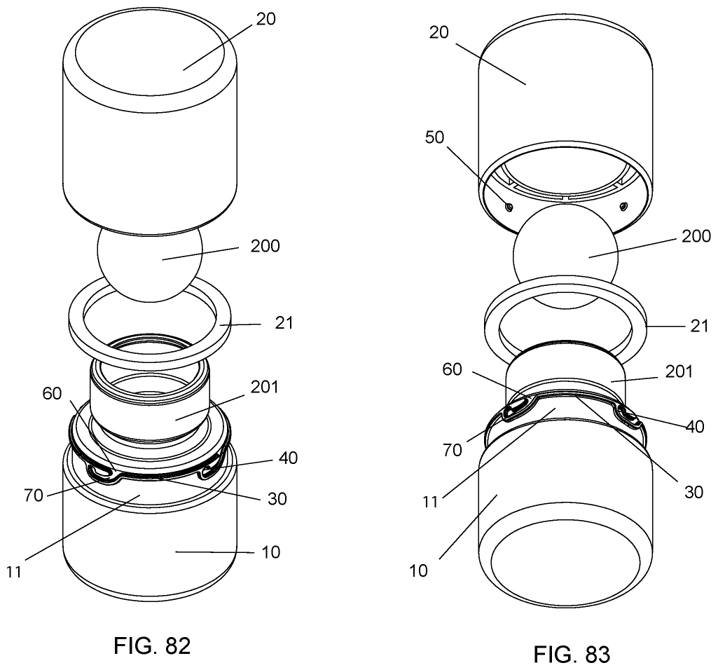

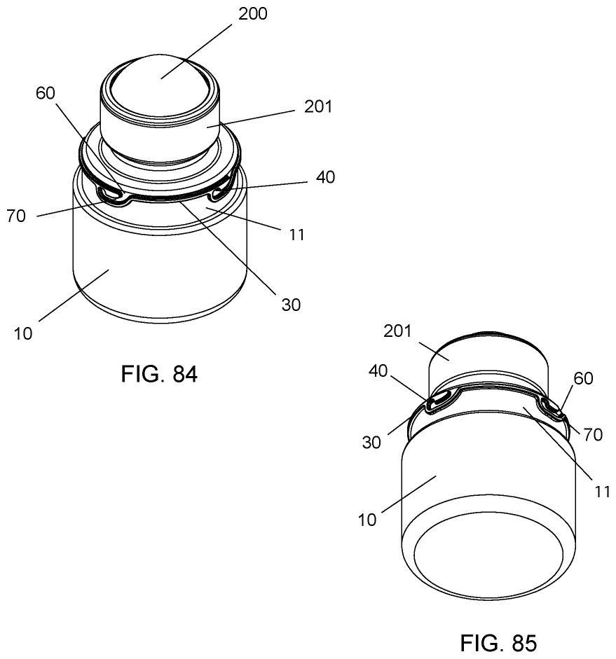

FIG. 82 is a perspective exploded view of one embodiment of the child-resistant container of FIG. 75; FIG. 83 is a perspective exploded view of one embodiment of the child-resistant container of FIG. 75; FIG. 84 is a perspective view of one embodiment of the child-resistant container of FIG. 75; and, FIG. 85 is a perspective view of one embodiment of the child-resistant container of FIG. 75. Referring to FIGS. 82-84, in addition to the body 10, cap 20, cap membrane 21, pegs 50, neck 11, inlet 60, track 70, thread 30 and, notches 40, the child-resistant roll-on container is further defined by a ball 200 housed within a housing 201. In use, when the cap 20 is removed, a user may roll the substance contained within the child resistant container only the skin by turning the container upside down and maneuvering the ball 200 over the skin, whereby the ball 200 rolls within the housing 201 and absorbs and/or picks up the substance in the container, which is then exposed to the environment as the ball 200 rolls within the housing 201. The substance within the child-resistant container roll on tube may be a liquid, gel, paste, or lotion.

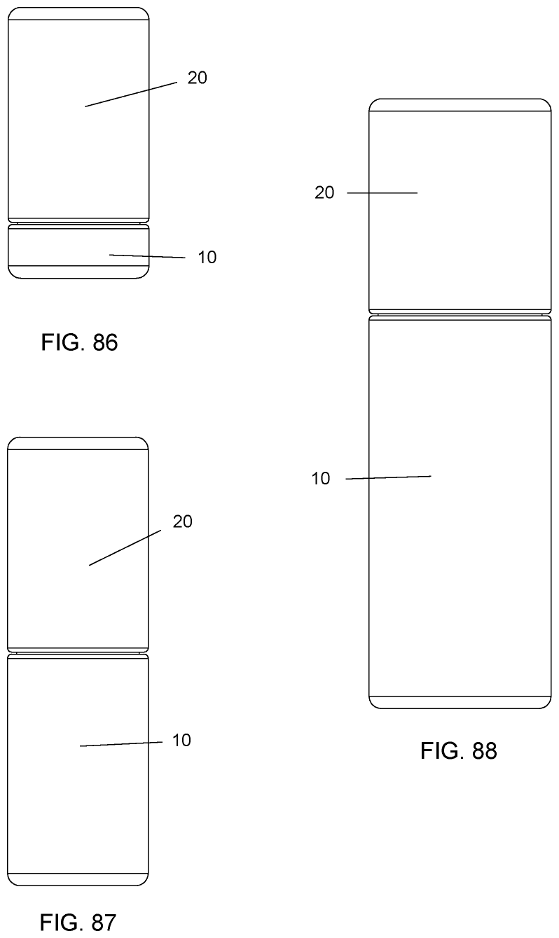

FIG. 86 is a front view of one embodiment of the child-resistant container in a closed configuration. Referring to FIG. 86, in one embodiment, the body 10 of the child-resistant container is 13 mm high and holds 5 mL of liquid. FIG. 87 is a front view of one embodiment of the child-resistant container in a closed configuration. Referring to FIG. 87, in one embodiment, the body 10 of the child-resistant container is 29 mm high and holds 15 mL of liquid. FIG. 88 is a front view of one embodiment of the child-resistant container in a closed configuration. Referring to FIG. 88, in one embodiment, the body 10 of the child-resistant container is 56 mm high and holds 30 mL of liquid. Referring to FIGS. 86-88, the cap may be 34 mm in diameter and 52 mm high.

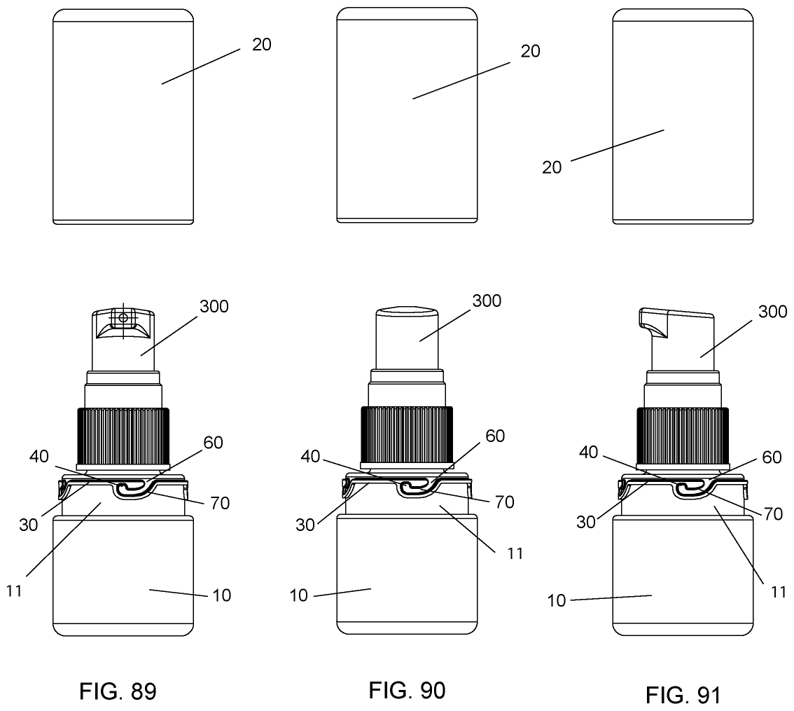

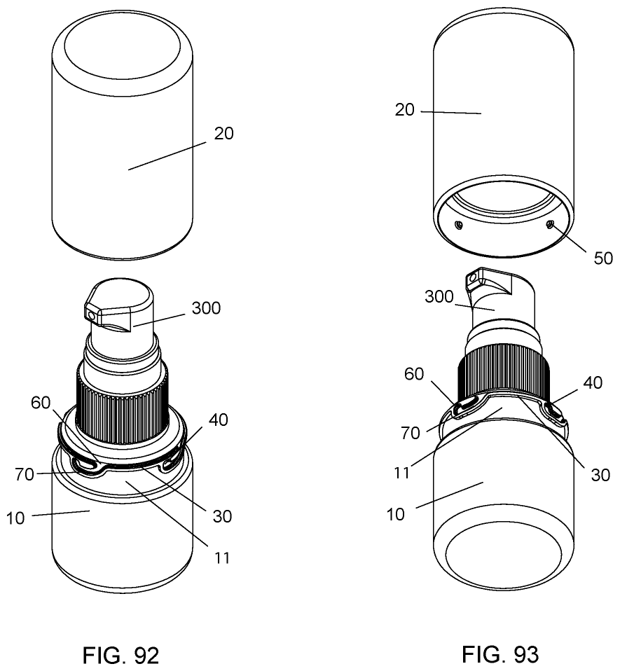

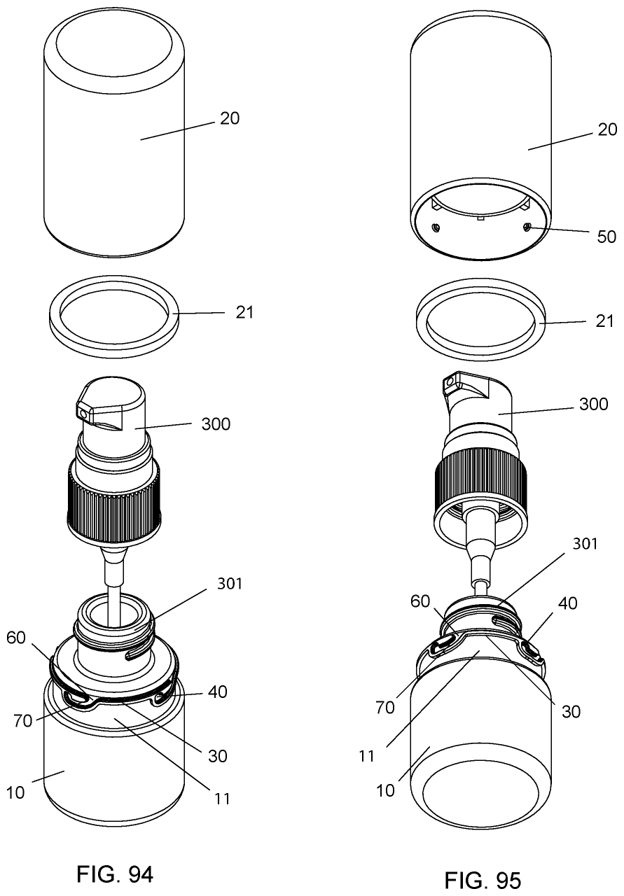

FIG. 89 is a front exploded view of one embodiment of the child-resistant container; FIG. 90 is a back exploded view of one embodiment of the child-resistant container of FIG. 89; FIG. 91 is a side exploded view of one embodiment of the child-resistant container of FIG. 89; FIG. 92 is a perspective exploded view of one embodiment of the child-resistant container of FIG. 89; FIG. 93 is a perspective exploded view of one embodiment of the child-resistant container of FIG. 89; FIG. 94 is a perspective exploded view of one embodiment of the child-resistant container of FIG. 89; and, FIG. 95 is a perspective exploded view of one embodiment of the child-resistant container of FIG. 89.

Referring to FIGS. 89-95, in an alternative embodiment, in addition to the body 10, cap 20, cap membrane 21, pegs 50, neck 11, inlet 60, track 70, thread 30 and, notches 40, the child-resistant container may be further defined by a pump dispenser 300. Referring to FIGS. 94 and 95, the pump dispenser 300 may be secured to the child-resistant container via a threaded opening 301. The pump dispenser 301 allows a user to easily pump a liquid, gel, paste, or lotion out of the child-resistant container by pressing down on the pump dispenser 301.

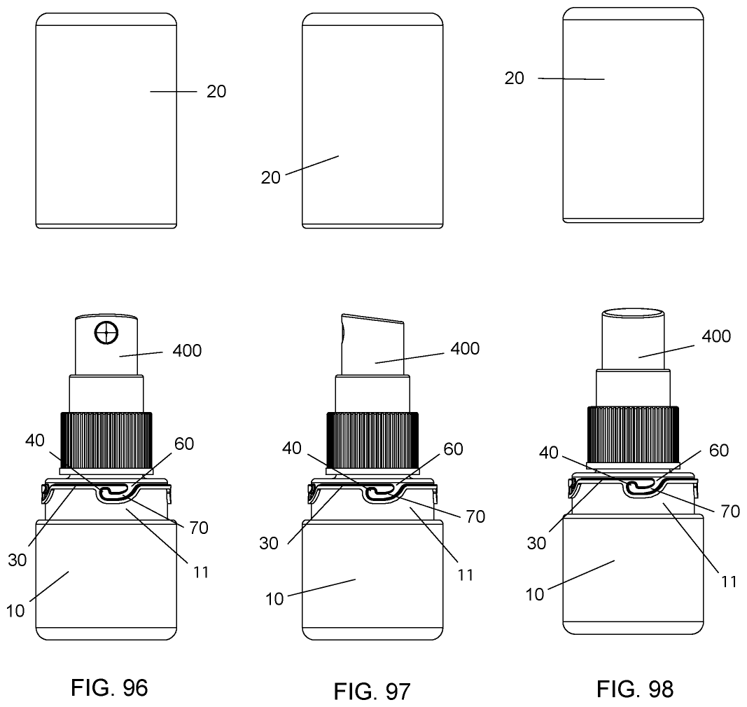

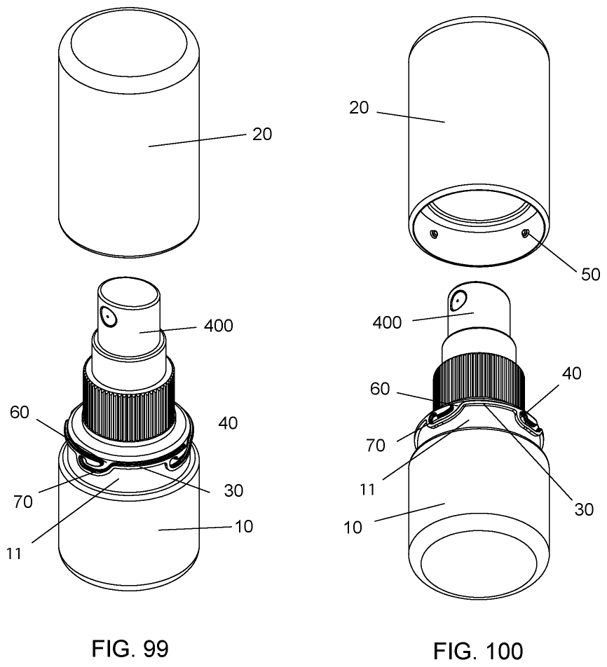

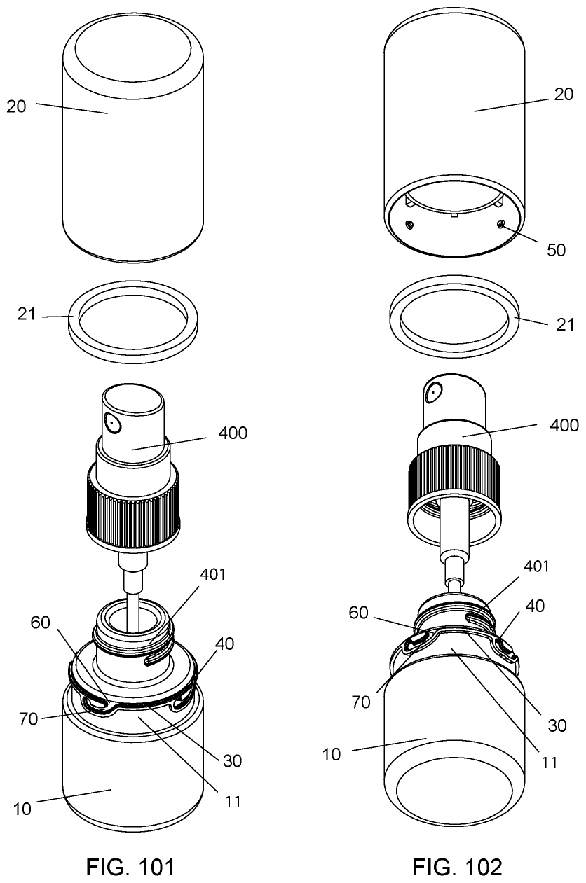

FIG. 96 is a front exploded view of one embodiment of the child-resistant container; FIG. 97 is a back exploded view of one embodiment of the child-resistant container of FIG. 96; FIG. 98 is a side exploded view of one embodiment of the child-resistant container of FIG. 96; FIG. 99 is a perspective exploded view of one embodiment of the child-resistant container of FIG. 96; FIG. 100 is a perspective exploded view of one embodiment of the child-resistant container of FIG. 96; FIG. 101 is a perspective exploded view of one embodiment of the child-resistant container of FIG. 96; and, FIG. 102 is a perspective exploded view of one embodiment of the child-resistant container of FIG. 96.

Referring to FIGS. 96-102, in an alternative embodiment, in addition to the body 10, cap 20, cap membrane 21, pegs 50, neck 11, inlet 60, track 70, thread 30 and, notches 40, the child-resistant container may be further defined by a spray nozzle 400.

Referring to FIGS. 101 and 102, the spray nozzle 400 may be secured to the child-resistant container via a threaded opening 401. The spray nozzle 400 allows a user to easily spray a liquid out of the child-resistant container by pressing down on the spray nozzle 400.

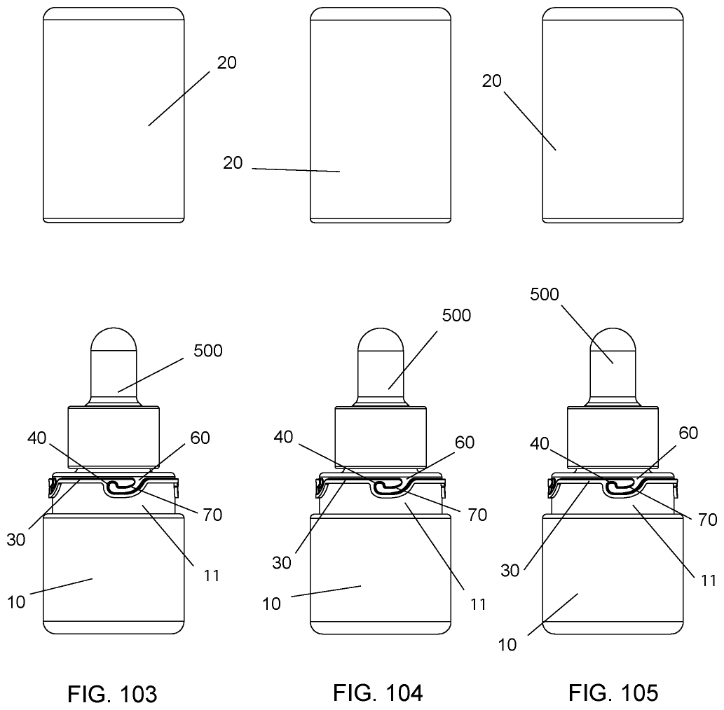

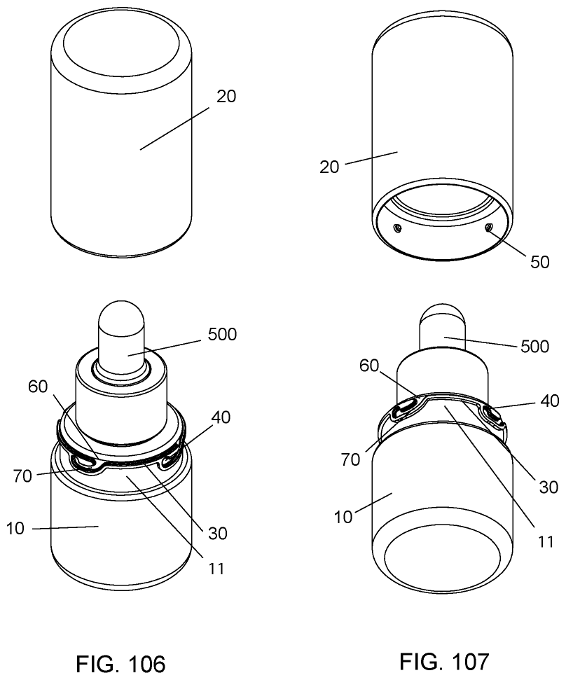

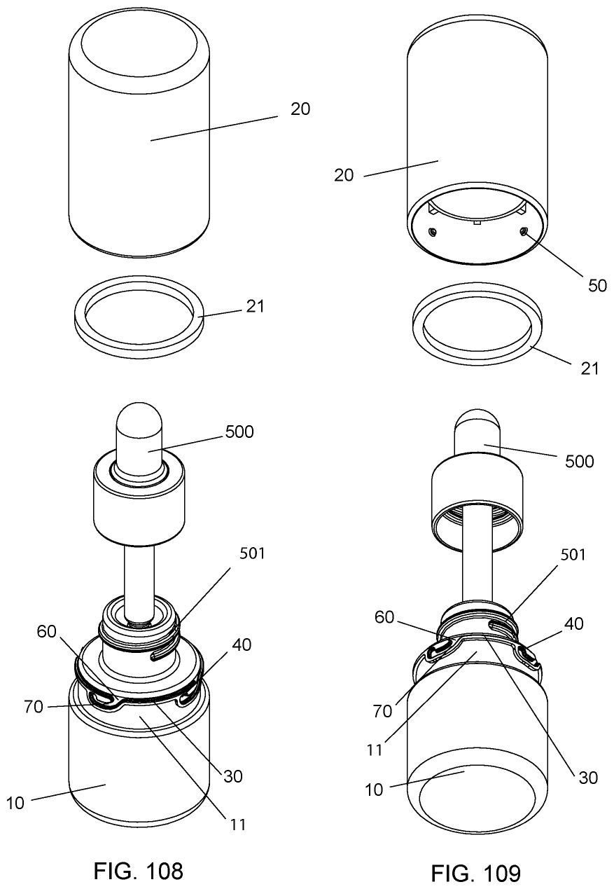

FIG. 103 is a front exploded view of one embodiment of the child-resistant container; FIG. 104 is a back exploded view of one embodiment of the child-resistant container of FIG. 103; FIG. 105 is a side exploded view of one embodiment of the child-resistant container of FIG. 103; FIG. 106 is a perspective exploded view of one embodiment of the child-resistant container of FIG. 103; FIG. 107 is a perspective exploded view of one embodiment of the child-resistant container of FIG. 103; FIG. 108 is a perspective exploded view of one embodiment of the child-resistant container of FIG. 103; and, FIG. 109 is a perspective exploded view of one embodiment of the child-resistant container of FIG. 103.

Referring to FIGS. 103-109, in an alternative embodiment, in addition to the body 10, cap 20, cap membrane 21, pegs 50, neck 11, inlet 60, track 70, thread 30 and, notches 40, the child-resistant container may be further defined by a dropper 500.

Referring to FIGS. 108 and 109, the dropper 500 may be secured to the child-resistant container via a threaded opening 501. The dropper 500 allows a user to easily draw a liquid out of the child-resistant container and expel it by squeezing bulb on the dropper 500 while it is within the container to draw liquid into the dropper, removing the dropper 500 from the container, and then squeezing the bulb to release the liquid contained within the dropper 500.

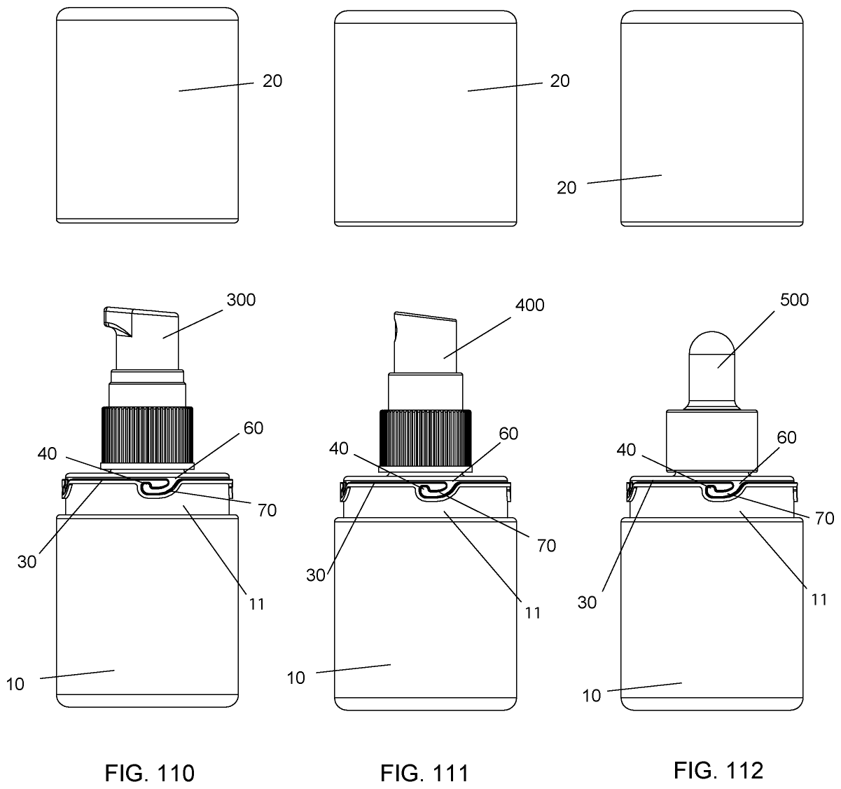

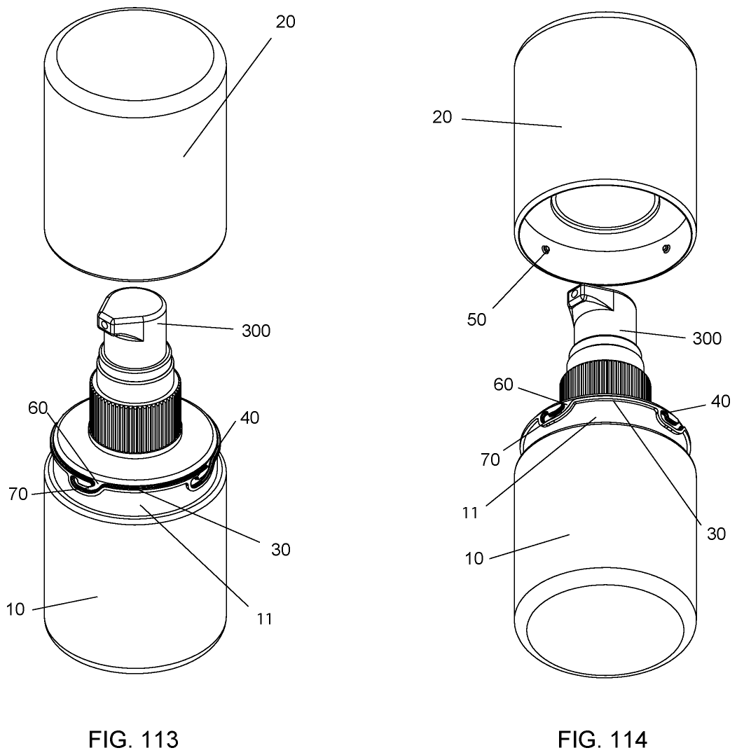

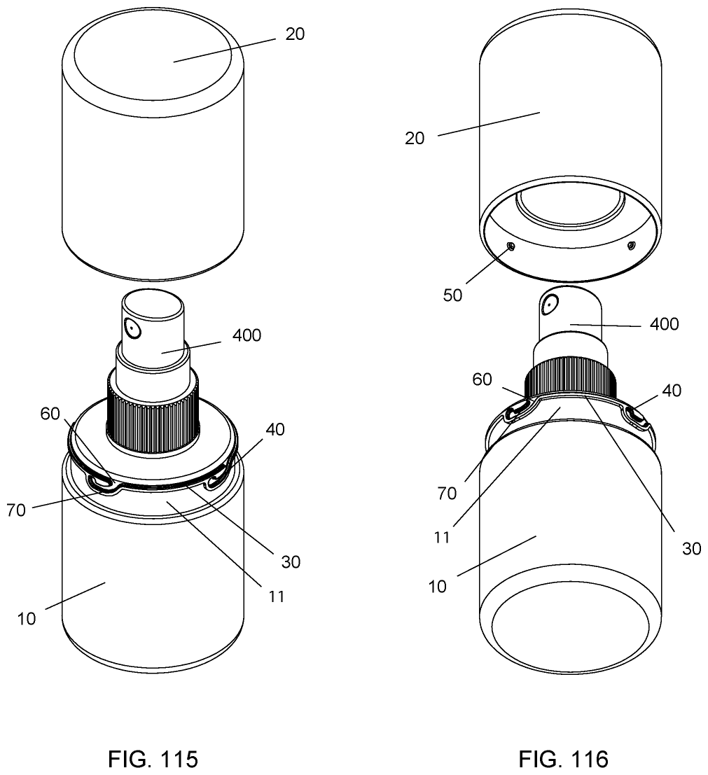

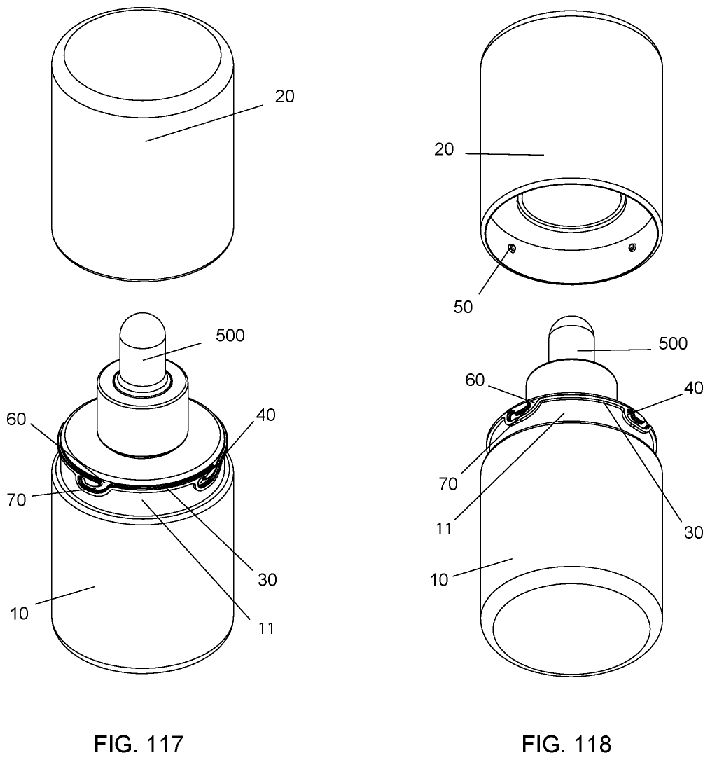

FIG. 110 is a front exploded view of one embodiment of the child-resistant container; FIG. 111 is a front exploded view of one embodiment of the child-resistant container; FIG. 112 is a front exploded view of one embodiment of the child-resistant container; FIG. 113 is a perspective exploded view of one embodiment of the child-resistant container; FIG. 114 is a perspective exploded view of one embodiment of the child-resistant container; FIG. 115 is a perspective exploded view of one embodiment of the child-resistant container; FIG. 116 is a perspective exploded view of one embodiment of the child-resistant container; FIG. 117 is a perspective exploded view of one embodiment of the child-resistant container; and, FIG. 118 is a perspective exploded view of one embodiment of the child-resistant container.

Referring to FIGS. 110-118, in one embodiment, the body 10 may be a wider in diameter and hold 50 mL of liquid. In another embodiment, the body 10 may hold 100 mL in of liquid. In a preferred embodiment, the body may be 465 mm high to 95 mm high. In a preferred embodiment, the cap 20 may be 44 mm in diameter and 52 mm high.

Referring to FIGS. 58-118, the child-resistant container has the same securing and locking mechanism as described in FIGS. 1-57.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

We claim:

1. A container comprising:
a body with a neck, wherein the neck is further defined by a thread, wherein the thread is further defined by an inlet, a track, and a notch;
a cap, wherein the cap is further defined by at least one peg located on the inside wall of the cap and a cap membrane in communication with the inside base of the cap; and,
a nozzle.

2. The container of claim 1, wherein body is a tube.

3. A container comprising:
a body with a neck, wherein the neck is further defined by a thread, wherein the thread is further defined by an inlet, a track, and a notch;
a cap, wherein the cap is further defined by at least one peg located on the inside wall of the cap and a cap membrane in communication with the inside base of the cap; and,
a ball located within a housing on top of the neck of the container.

4. A container comprising:
a body with a neck, wherein the neck is further defined by a thread, wherein the thread is further defined by an inlet, a track, and a notch;
a cap, wherein the cap is further defined by at least one peg located on the inside wall of the cap and a cap membrane in communication with the inside base of the cap; and,
a dispenser secured to a threaded opening on top of the neck of the container.

5. The container of claim 4, wherein the dispenser is a pump dispenser.

6. The container of claim 4, wherein the dispenser is a spray nozzle.

7. The container of claim 4, wherein the dispenser is a dropper.
